(19) United States
(12) Patent Application Publication
(10) Pub. No.: US 2005/0240875 A1
(43) Pub. Date: Oct. 27, 2005

(54) Method and apparatus for providing information

(75) Inventors: Kuniharu Takayama, Kawasaki (JP); Hirohisa Naito, Kawasaki (JP); Yoshiharu Maeda, Kawasaki (JP); Hisashi Hasegawa, Kawasaki (JP); Taiji Okamoto, Kawasaki (JP); Hiroshi Nagazono, Kawasaki (JP); Hiroyuki Ohira, Kawasaki (JP); Etsuko Tomitaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/159,184

(22) Filed: Jun. 23, 2005

Related U.S. Application Data
(63) Continuation of application No. PCT/JP03/04637, filed on Apr. 11, 2003.

(51) Int. Cl. G06F 3/00

(52) U.S. Cl. 715/745

(57) ABSTRACT

An information providing device, which provides information (such as web page) to a client device via a network, includes: a usage history storing unit that stores a usage history of each web page into a usage history database, and calculates a utilization rate of each web page based on the usage history; a display style changing unit that changes a style of displaying a link to the web page or the web page itself based on the utilization rate and display settings; and a display settings changing unit that changes the display settings according to an instruction from a user and stores the display settings in a display settings storage unit.

### BACKGROUND OF THE INVENTION

1) Field of the Invention

The present invention relates to a technology for providing information to a user in such a way that the user can find necessary information (such as web pages, documents, and folders) easily from among an enormous amount of information stored in a network or a computer system.

2) Description of the Related Art

Recently, a network and a computer can include a lot of information, such as documents and images. These information are linked to each other by a link in a hypertext, such as a Hyper Text Markup Language (HTML) file, thereby enabling a user to access various kinds of information through the link (see “HTML 4.0 Specification” W3C Recommendation, revised on 24 Apr. 1998, URL:http://www.w3.org/TR/1998/REC-html140-19980424/[Searched on 14 Mar. 2003]). The user can find necessary information through a portal site functioning as a telephone directory, a search engine functioning as a number guidance, or a bookmark in which the user registers frequently-referenced web pages. In a conventional technology disclosed in Japanese Patent Application Laid-Open No. H10-334120, items in the bookmark are automatically rearranged in the order of reference times or reference frequency, thereby enabling the user to find necessary information easily and efficiently.

However, since a lot of web pages are listed on the portal site, in a search result page created by the search engine, or the bookmark, it can be still hard for the user to find the necessary information.

### SUMMARY OF THE INVENTION

It is an object of the present invention to at least solve the problems in the conventional technology.

A method according to an aspect of the present invention, which is a method of providing information to a client device via a network, includes: storing a usage history of the information; and changing a style of displaying the information based on the usage history.

A computer-readable recording medium according to another aspect of the present invention stores a computer program that causes a computer to execute the above method.

An information providing device according to still another aspect of the present invention, which provides information to a client device via a network, includes: a usage history storing unit that stores a usage history of the information; and a display style changing unit that changes a style of displaying the information based on the usage history.

An information display device according to still another aspect of the present invention, which displays information in response to a request from a user, includes: a usage history storing unit that stores a usage history of the information; and a display style changing unit that changes a style of displaying the information based on the usage history.

The other objects, features, and advantages of the present invention are specifically set forth in or will become apparent from the following detailed description of the invention when read in conjunction with the accompanying drawings.

### BRIEF DESCRIPTION OF THE DRAWINGS

FIGS. 1A and 1B are diagrams for explaining a difference between a conventional web page list and a web page list according to a first embodiment of the present invention;

FIG. 2 is a block diagram of an information providing system according to the first embodiment;

FIG. 3 is a schematic diagram of a usage history stored in a usage history database (DB);

FIG. 4 is a flowchart of a process performed by the information providing system;

FIG. 5 is a flowchart of a utilization rate calculation performed by a usage history storing unit shown in FIG. 2;

FIG. 6 is a flowchart of a process performed by a display settings changing unit shown in FIG. 2;

FIG. 7 a diagram for explaining how the display style is changed according to the first embodiment;

FIG. 8 is another diagram for explaining how the display style is changed according to the first embodiment;

FIG. 9 is still another diagram for explaining how the display style is changed according to the first embodiment;

FIG. 10 is a block diagram of another information providing system according to the first embodiment;

FIG. 11 is a diagram for explaining how the display style is changed according to a second embodiment of the present invention;

FIG. 12 is a block diagram of the information display device according to the second embodiment; and

FIG. 13 is a diagram of a computer system executing a computer program according to the present invention.

### DETAILED DESCRIPTION

Exemplary embodiments of the present invention are explained below in detail with reference to the accompanying drawings.

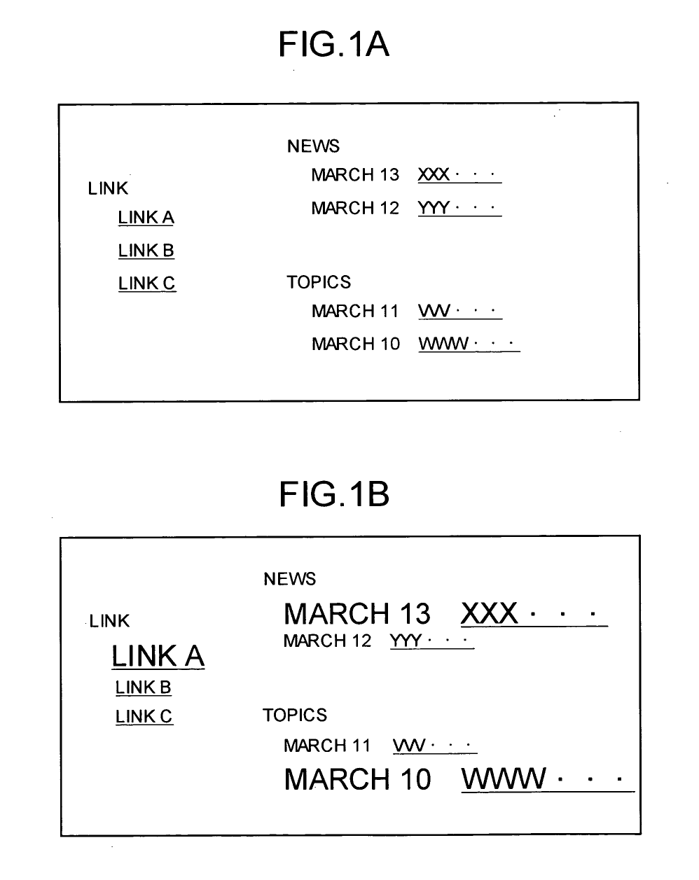

FIG. 1A illustrates a web page list displayed in a conventional technology, whereas FIG. 1B illustrates a web page list according to a first embodiment of the present invention. Conventionally, as shown in FIG. 1A, links to the respective web pages are displayed in the same size and the same color determined in advance. On the other hand, in the web page list shown in FIG. 1B, links that has been clicked by many users are displayed in large characters. For example, a news item “March 13 XXX . . . ” and a topics item “March 10 WWW . . . ” are displayed in larger characters than those of other items, since they have been referred to by many users. Similarly, “LINK A” is displayed in larger characters since it has been referred to by many users.

According to the first embodiment, users can easily find frequently-referenced web pages since the links to them are displayed in a larger size. Not only larger characters, but also bold characters or characters of different colors can be used for the links. Furthermore, color of images and backgrounds,, width of lines, and the like can be changed according to frequency of use of each web page, by referring to a usage history in which a utilization rate of each web page is calculated for each category of users (details will be explained later).

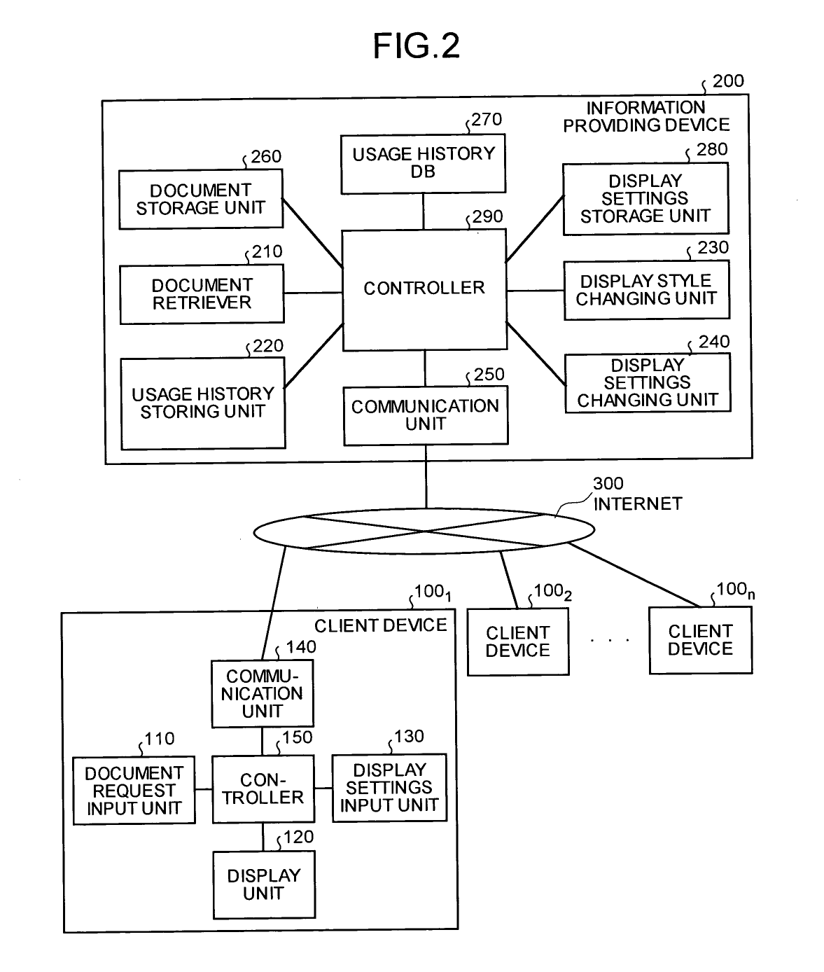

FIG. 2 is a block diagram of an information providing system according to the first embodiment. An information providing device 200 provides client devices 100₁ to 100ₙ with information (in the first embodiment, web pages) via the Internet 300.

Each of the client devices 100₁ to 100ₙ includes: a document request input unit 110 used by the users to designate a web page and input a request for the web page; a display unit 120 that displays the requested web page; a display settings input unit 130 used by the users to input display settings; a communication unit 140 that communicates with the information providing device 200 via the Internet 300; and a controller 150 that controls the above units.

The information providing device 200 includes a document retriever 210, a usage history storing unit 220, a display style changing unit 230, a display settings changing unit 240, a communication unit 250, a document storage unit 260, a usage history database (DB) 270, a display settings storage unit 280, and a controller 290.

The document retriever 210 retrieves the designated web page from the document storage unit 260, transmits the web page to the display style changing unit 230, and informs the usage history storing unit 220 about which web page is requested.

The usage history storing unit 220 stores a usage history of each web page, and calculates a utilization rate of each web page based on the usage history. In the first embodiment, users of the information providing system are classified into a plurality of categories. A user and a manager of the information providing device 200 can define each categories based on gender, age, married/unmarried, occupation, hobby, age, address, current location, and access route of a user. The users classified into the same category as a user who has requested a web page are called “target users”, and the utilization rate is calculated as follows: (the number of times for which a web page is referred to by target users during a predetermined period)/(the number of times for which the web page is referred to by all the users during the predetermined period). Therefore, the more frequently the target users refer to the web page, the higher its utilization rate becomes, and the less frequently the target users refer to the web page, the lower its utilization rate becomes.

Alternatively, the utilization rate can be calculated as follows:

(the number of times for which a web page is referred to by target users last week)/(the number of times for which the web page is referred to by the target users in the week before last). Such a utilization rate indicates a transition of interest in time of the target users. The utilization rate can be also calculated as follows: (the number of times for which a web page is referred to by target users during a predetermined period)/(the number of times for which all web pages on the information providing device 200 are referred to by the target users during the predetermined period). Such a utilization rate indicates a usage rate of each web page to those of other web pages.

It is also possible to calculate the utilization rate based on: the total time for which a web page is referred to; the total time×the total number of times for which a web page is referred to; and the like. The “target users” can be any one of “users who belong to a specific category” and “all users”. The “users who belong to a specific category” can be “specific users”. A user or a manager of the information providing device 200 can designate how the utilization rate is calculated by changing the display settings.

The display style changing unit 230 changes a display style of a web page transmitted from the document retriever 210, based on the utilization rate calculated by the usage history storing unit 220. The display style changing unit 230 changes the size and the depth of colors of characters of each link included the web page, or changes the depth of the background color of the web page, thereby enabling a user to efficiently find frequently-referenced web pages.

The display settings changing unit 240 changes the display settings, which determine how the utilization rate is calculated and how the links to frequently-referenced information are emphasized (the display settings can include settings of color, brightness, color depth, shape, size, and width of lines of characters, images, and background the characters and the images), according to an instruction from a user or a manager of the information providing device 200. The display settings changing unit 240 stores the display settings in the display settings storage unit 280.

The communication unit 250 communicates with the client devices 100₁ to 100ₙ via the Internet 300. The communication unit 250 receives the request for a web page and the display settings from the client devices 100₁ to 100ₙ, and, transmits a requested web page to the client devices 100₁ to 100ₙ.

The document storage unit 260 stores web pages each of which is identified uniquely by a uniform resource locater (URL).

The usage history DB 270 stores a usage history of web pages stored in the document storage unit 260. The usage history storing unit 220 stores the usage history of each web page in the usage history DB 270, and calculates the utilization rate of each web page based on the usage history.

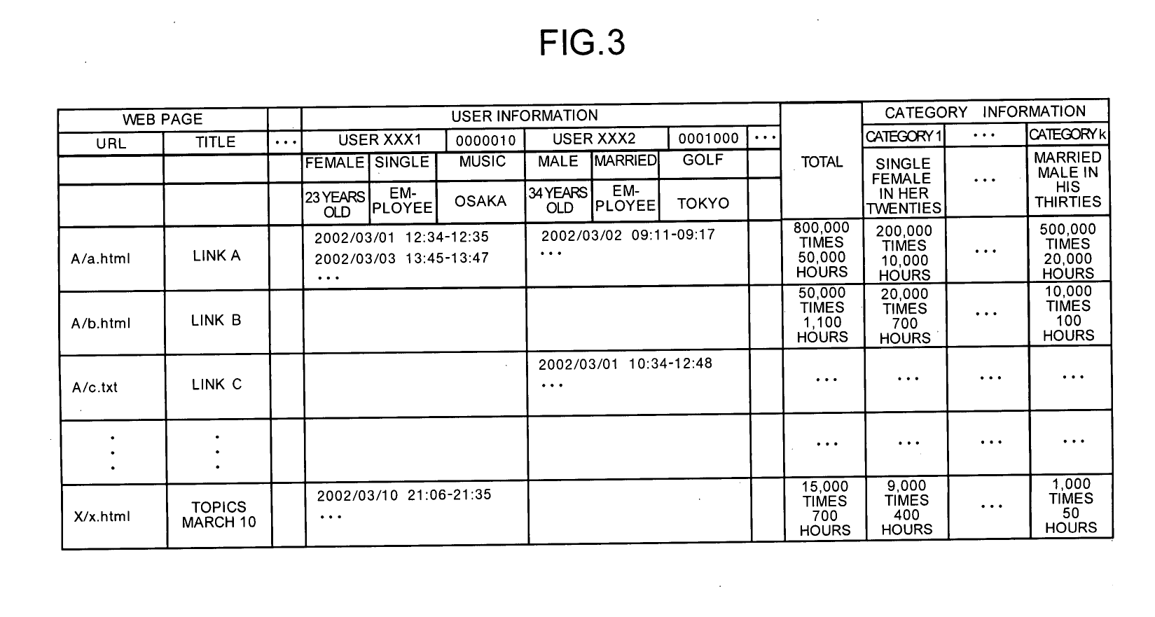

FIG. 3 is a schematic diagram of the usage history stored in the usage history DB 270. As shown in FIG. 3, the usage history includes URL, title, usage date/time of each user, total time/total number of times of all users/users belonging to each category.

For example, the web page whose URL is “A/a.html” and whose title is “LINK A” was accessed by a “user XXX1” during a period “from 12:34 to 12:35 on Mar. 1, 2002” and during a period “from 13:45 to 13:47 on Mar. 3, 2002”, and by a “user XXX2” during a period “from 09:11 to 09:17 on Mar. 2, 2002”. The total number of reference by all users is “800,000 times”, and the total hour of reference by all users is “50,000 hours”. Users of a “category 1” have accessed the web page for “200,000 times” and for “10,000 hours”, and users of a “category k” have accessed the web page for “500,000 times” and for “20,000 hours”.

User information includes a user name and a user-identification (ID) for each user, as well as attributes for classifying users into a plurality of categories, such as gender, married/unmarried, hobby, age, occupation, and address. For example, a user whose name is “user XXX1” and whose user ID is “0000010” is a “single” “23-year old” “female”, whose occupation is “a company employee”, whose hobby is “music”, and who lives in “Osaka”.

Category information includes definition of each category. For example, users who belong to a “category 1” are “single females in their twenties”, and users who belong to the “category k” are “married males in their thirties”.

The controller 290 controls exchange of data or control between the above units, thereby controlling the entire information providing device 200.

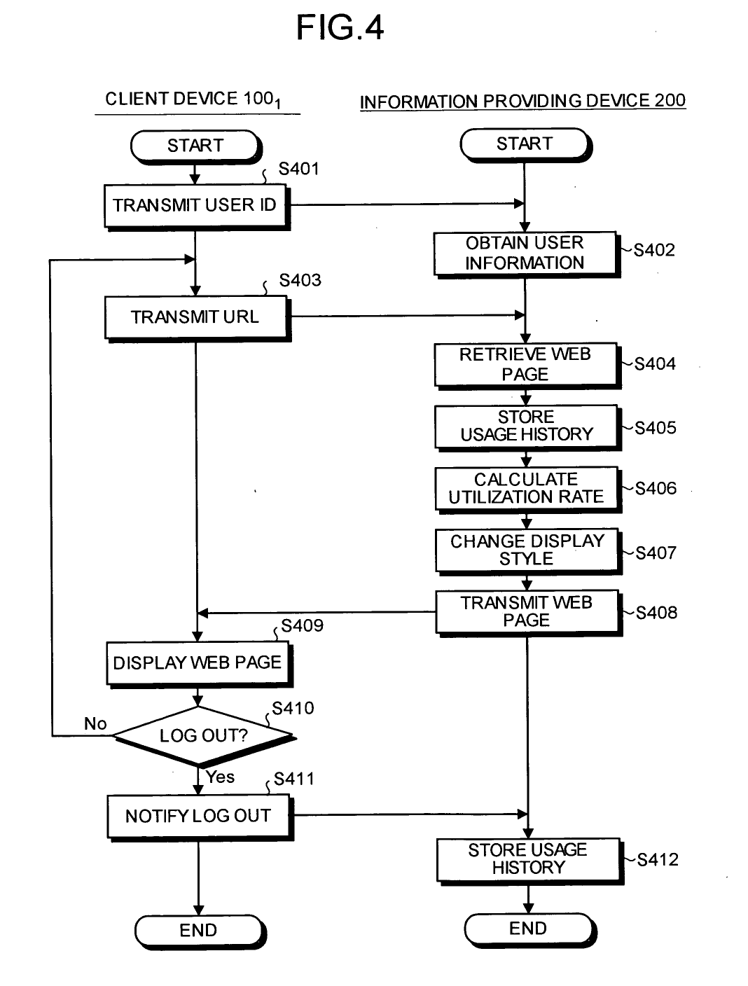

FIG. 4 is a flowchart of a process performed by the information providing system according to the first embodiment. Let us assume that the user requests for a web page to the information providing device 200 through the client device 100₁.

As shown in FIG. 4, the client device 100₁ transmits a user ID input from the user, to the information providing device 200 (step S401). The information providing device 200 receives the user ID, and obtains user information such as a category to which the user belongs, from the usage history DB 270 (step S402).

The client device 1001 transmits a URL input from the user, to the information providing device 200 (step S403). The document retriever 210 of the information providing device 200 obtains a web page identified by the URL, from the document storage unit 260 (step S404). The usage history storing unit 220 stores the usage history of the web page to be displayed (specifically, the start time of an access) and the usage history of a web page currently displayed (specifically, the end time of an access), into the usage history DB 270 (step S405). However, when the web page currently displayed is not any one of the web pages on the information providing device 206 (in other words, when the web page is provided by another information providing device than the information providing device 200), the usage history storing unit 220 does not store the usage history of the web page.

The usage history storing unit 220 calculates the utilization rate of each link included in the web page (step S406). The display style changing unit 230 changes the display style of each link based on the utilization rate (step S407). The communication unit 250 transmits the web page to the client device 100, (step S408).

The client device 1001 displays the web page (step S409), and waits for the next input from the user. When the next input is not log out (step S410: No), the process returns to step S403, and the client device 100₁ transmits a URL to the information providing device 200.

On the other hand, when the next input is log out (step S410: Yes), the client device 100₁ notifies a log out to the information providing device 200 (step S411). The information providing device 200 stores the usage history of the web page currently displayed (specifically, the end time of an access) into the usage history DB 270 (step S412).

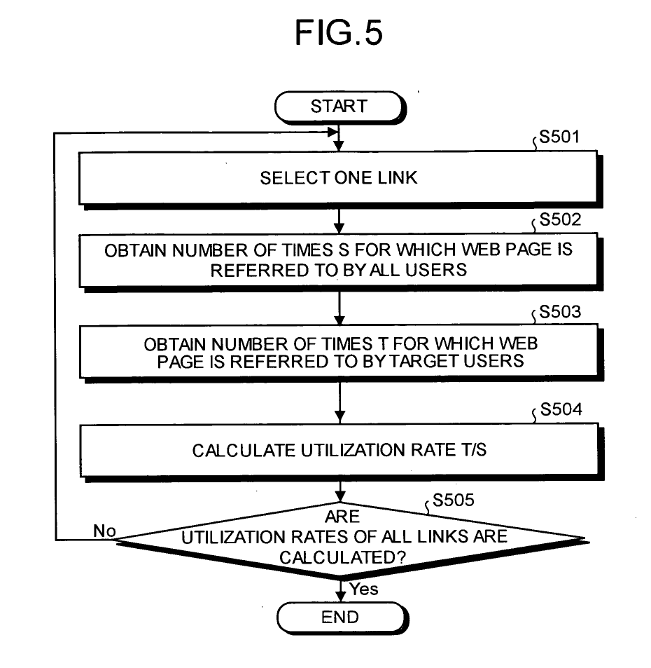

FIG. 5 is a flowchart of the utilization rate calculation, which is performed at step S406 shown in FIG. 4 by the usage history storing unit 220 shown in FIG. 2.

As shown in FIG. 5, the usage history storing unit 220 selects one link from the web page obtained by the document retriever 210 (step S501), and obtains the number of times S for which a web page corresponding to the link is referred to by all users from the usage history DB 270 (step S502).

The usage history storing unit 220 obtains the number of times T for which the web page is referred to by target users from the usage history DB 270 (step S503). The usage history storing unit 220 calculates a utilization rate T/S of the selected link (step S504), and stores the calculated utilization rate T/S in a storage area so that the display style changing unit 230 can read the utilization rate of each link.

The usage history storing unit 220 determines whether the utilization rates of all links are calculated (step S505). When the utilization rates of all links are calculated (step S505: Yes), the usage history storing unit 220 finishes the process. When the utilization rates of all links are not calculated (step S505: No), the process returns to step S501, and the usage history storing unit 220 calculates utilization rates of another link.

As explained above, the usage history storing unit 220 calculates utilization rates based on the usage history of each web page stored in the usage history DB 270, thereby enabling the display style changing unit 230 to change the display style of each link based on the utilization rate.

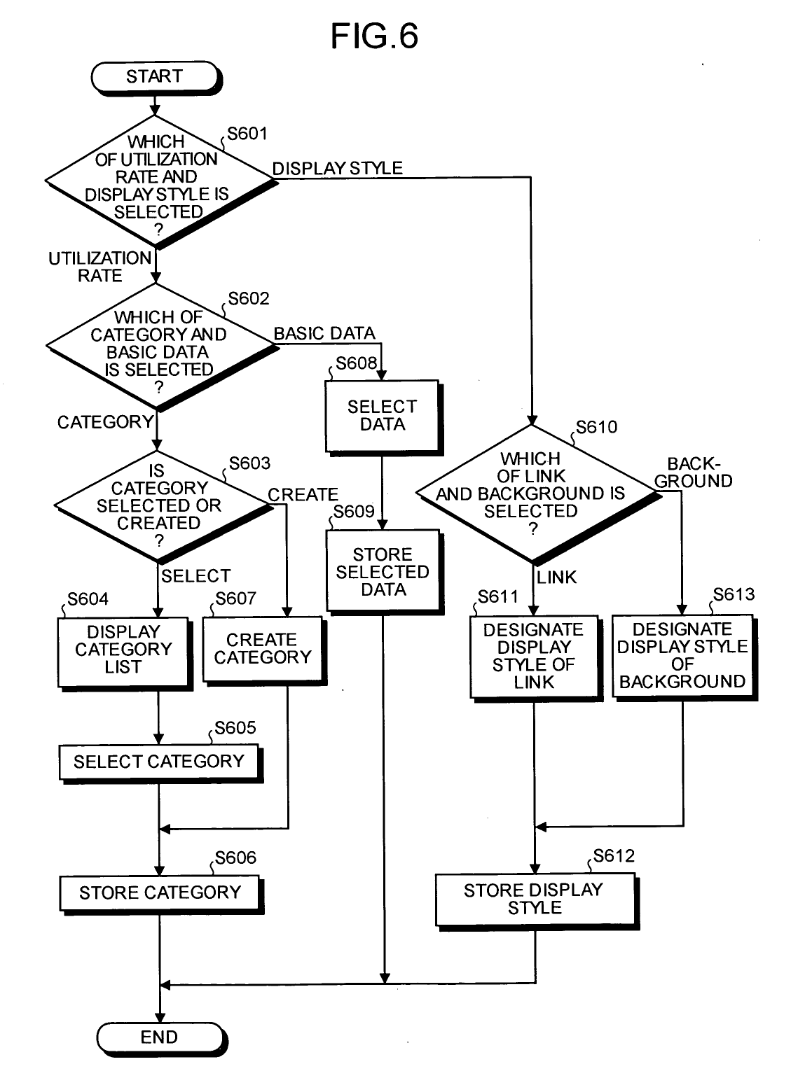

FIG. 6 is a flowchart of a process performed by the display settings changing unit 240 shown in FIG. 2. Let us assume that a manager of the information providing device 200 changes the display settings. However, users can also change the display settings through the client devices 100₁ to 100ₙ.

As shown in FIG. 6, the manager selects either “utilization rate” or “display style” through the display settings changing unit 240 (step S601). When selecting “utilization rate”, the manager further selects either “category” or “basic data” through the display settings changing unit 240 (step S602).

When selecting “category”, the manager further selects either another existing category or a newly-created category as a category to be used for the utilization rate calculation through the display settings changing unit 240 (step S603). When the manager selects another existing category, the display settings changing unit 240 displays a list of categories (step S604). When the manager selects a category from the list (step S605), the display settings changing unit 240 stores the selected category in the display settings storage unit 280 (step S606).

On the other hand, when the manager selects to create a new category, the display settings changing unit 240 creates a new category according to the instruction of the manager (step S607), and stores the created category in the display settings storage unit 280 (step S606).

When selecting “basic data”, the manager further selects, through the display settings changing unit 240, data to be used for the utilization rate calculation from among: the number of times for which a web page is referred to; the time for which the web page is referred to; and a product of the number of times and the time (step S608). The display settings changing unit 240 stores the selected data in the display settings storage unit 280 (step S609).

When selecting “display style”, the manager further selects either “link” or “background” through the display settings changing unit 240 (step S610). When selecting “link”, the manager designates the display style of a link through the display settings changing unit 240 (step S611), and the display settings changing unit 240 stores the display style into the display settings storage unit 280 (step S612).

On the other hand, when selecting “background”, the manager designates the display style of a background of the link through the display settings changing unit 240 (step S613), and the display settings changing unit 240 stores the display style into the display settings storage unit 280 (step S612). Thus, the manager and the user can change the display settings to suit their needs.

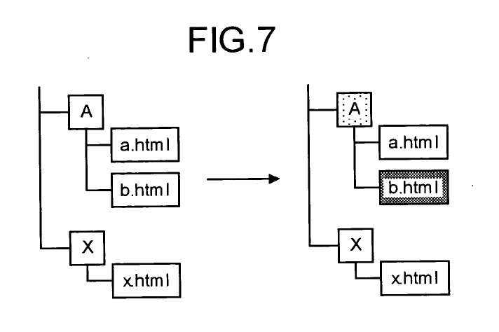

FIG. 7 is a diagram for explaining how the display style is changed according to the first embodiment. In the site map shown in FIG. 7, the background (surrounding) of a link to a frequently-referred web page (that is, “A/b.html”) is displayed in a deep color, thereby enabling the user to find the link easily. A slightly deep color is used for the background of a character string of the site “A” including the link “b.html”.

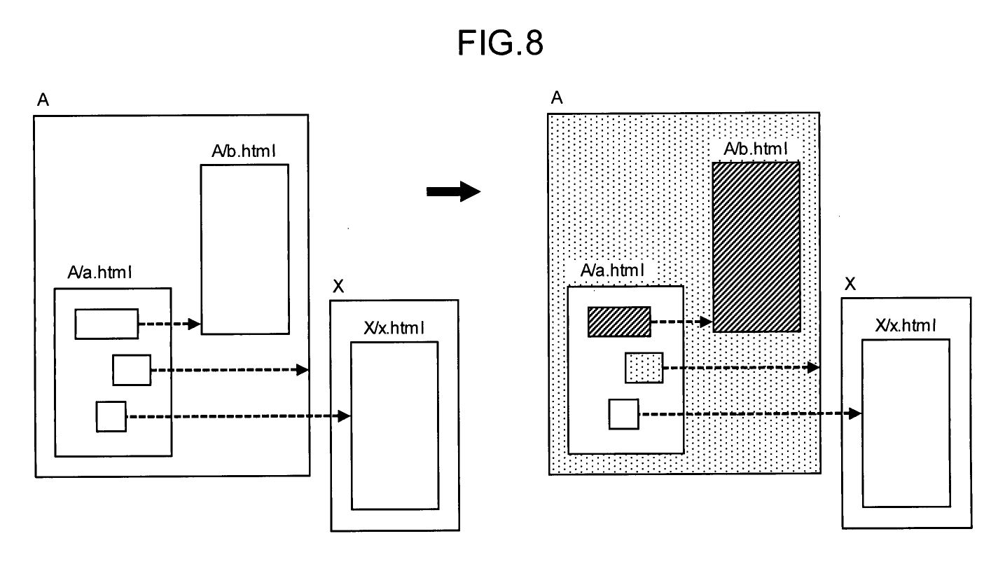

FIG. 8 is another diagram for explaining how the display style is changed according to the first embodiment. As shown in FIG. 8, a frequently-referred web page and a link thereto are emphasized in a deeper color. For example, the most frequently-referred web page “A/b.html” and the link thereto are displayed in the deepest color, whereas the second-frequently-referred web page “A” and the link thereto are displayed in a paler color.

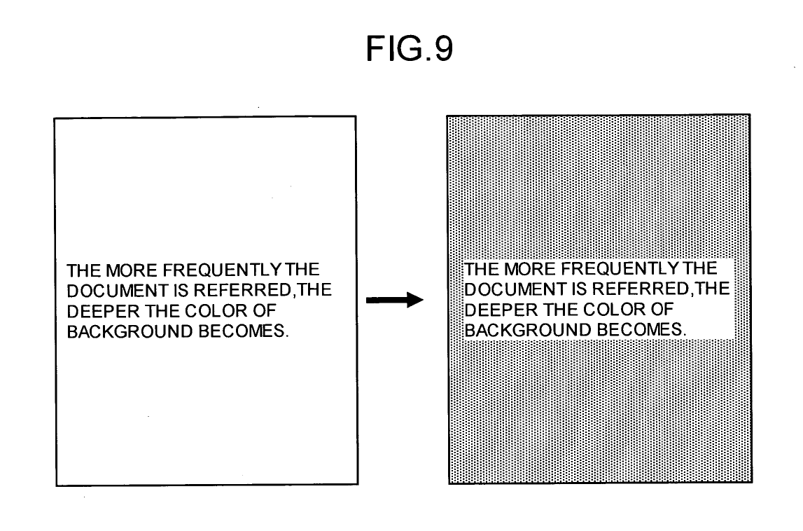

FIG. 9 is still another diagram for explaining how the display style is changed according to the first embodiment. As shown in FIG. 9, the background of the frequently-referred web page can be displayed in a deep color. The more frequently the web page (document) is referred, the deeper the color of the background becomes.

As described above, according to the first embodiment, the usage history storing unit 220 stores the usage history of each web page into the usage history DB 270, and calculates the utilization rate of each web page based on the usage history. The display style changing unit 230 changes the display style of the web page based on the utilization rate, thereby noticeably displaying the frequently-referred web page.

According to the first embodiment, the display settings changing unit 240 receives the display settings from the manager or the user, and stores the display settings in the display settings storage unit 280. The usage history storing unit 220 calculates the utilization rate according to the display settings stored in the display settings storage unit 280. The display style changing unit 230 changes the display style based on the display settings stored in the display settings storage unit 280, thereby making the display style fit to the needs of the manager and the user.

In the first embodiment, the display settings are input from the manager or the user. However, the information providing device 200 can determine the optimum display settings automatically, based on colors and sizes of characters included in a web page. For example, when a lot of colors are included in a web page, it is more preferable to change the size of characters than to change the color thereof. On the other hand, when a web page includes various sizes of characters and a small number of colors, it is preferable to change the color than the size.

In the first embodiment, the display style is changed for all users. However, the display style can be changed for only a part of users designated by the manager, such as users who have logged in a specific website, users who belong to a specific category, or expert users. Such users can be different from users whose accesses are used as the basic data for the utilization rate calculation.

In the first embodiment, the usage history storing unit 220 and the display style changing unit 230 are provided in the information providing device 200. Alternatively, these units can be provided in a device separate from the information providing device 200, to provide a display style changing service independently of the information providing service.

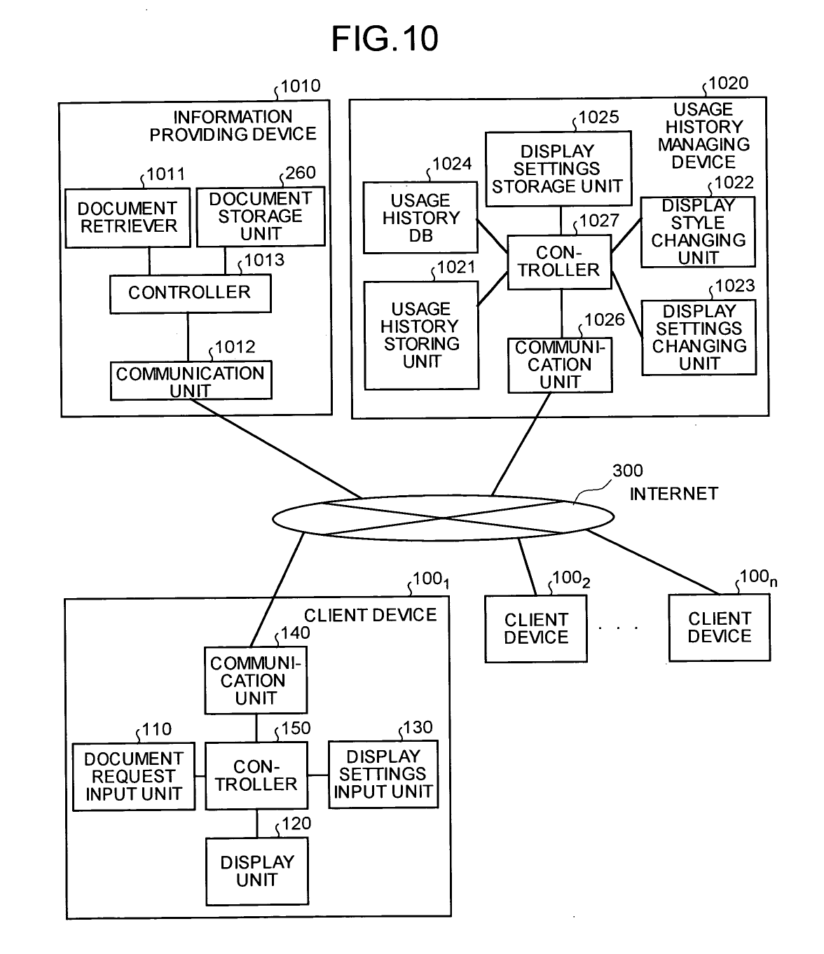

FIG. 10 is a block diagram of another information providing system according to the first embodiment. As shown in FIG. 10, the information providing system includes an information providing device 1010 that provides users with information (for example, web page), a usage history managing device 1020 that manages the usage history of each web page and changes the display style based on the usage history, and the client devices 100₁ to 100ₙ used by the users.

The information providing device 1010 has a document retriever 1011, a communication unit 1012, a controller 1013, and the document storage unit 260. The document retriever 1011 retrieves a web page requested from the client devices 100₁ to 100ₙ, from the document storage unit 260, and transmits the web page to the usage history managing device 1020. The communication unit 1012 communicates with the client devices 100₁ to 100ₙ, and the usage history managing device 1020. The controller 1013 controls the entire information providing device 1010.

The usage history managing device 1020 includes a usage history storing unit 1021, a display style changing unit 1022, a display settings changing unit 1023, a usage history DB 1024, a display settings storage unit 1025, a communication unit 1026, and a controller 1027.

The usage history storing unit 1021 accumulates the usage history of each web page provided by the information providing device 1010, and calculates the utilization rate of each web page based on the usage history. The display style changing unit 1022 changes the display style based on the utilization rate calculated by the usage history storing unit 1021.

The display settings changing unit 1023 changes the display settings based on the instruction from the user or the manager of the information providing device 1010. The communication unit 1026 communicates with the client devices 100₁ to 100ₙ, and the information providing device 1010 via the Internet 300.

The usage history DB 1024 stores the usage history of each web page provided by the information providing device 1010. The display settings storage unit 1025 stores the display settings input from the user or the manager. The controller 1027 controls the entire usage history managing device 1020.

In the first embodiment, the information providing device changes the display style for the client devices connected to the information providing device via the Internet, based on the usage history. However, the present invention can be applied to a stand-alone information display device.

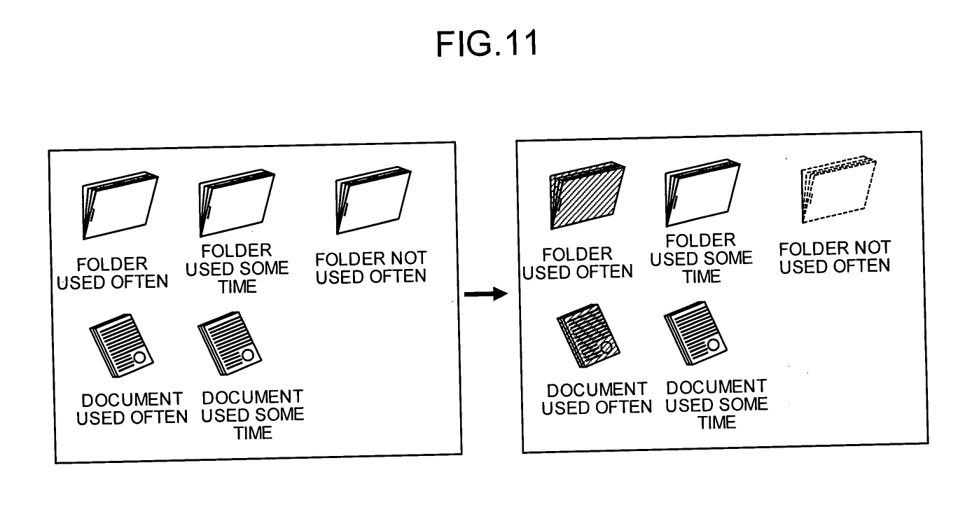

FIG. 11 is a diagram for explaining how the display style is changed by the information display device according to the second embodiment. As shown in FIG. 11, the information display device displays frequently-used folders and frequently-used documents, whereas indistinctly displays infrequently-used folders and infrequently-used documents, thereby enabling the user to find frequently-used folders or documents easily.

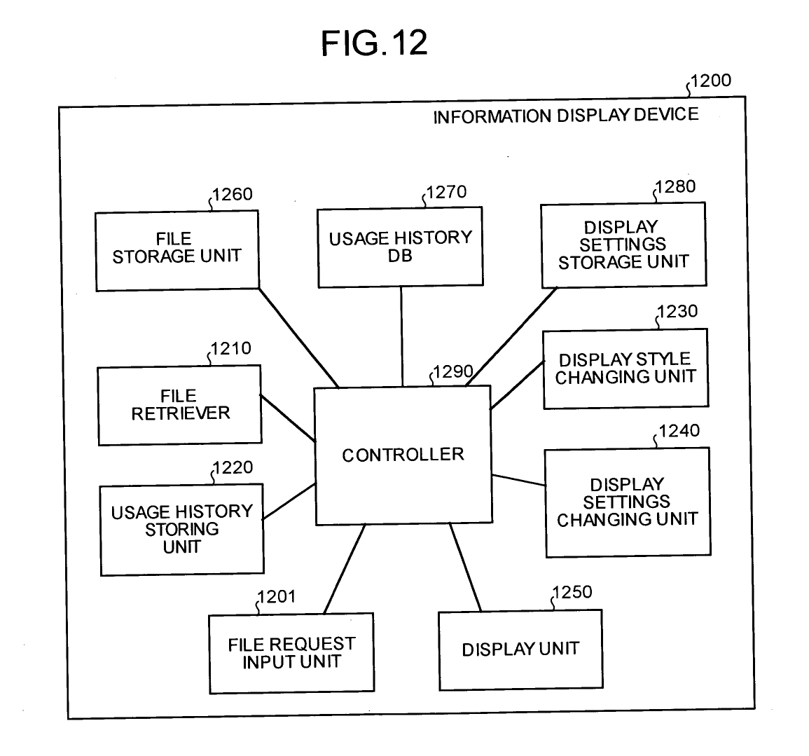

FIG. 12 is a block diagram of the information display device according to the second embodiment. As shown in FIG. 12, an information display device 1200 includes a file request input unit 1201, a file retriever 1210, a usage history storing unit 1220, a display style changing unit 1230, a display settings changing unit 1240, a display unit 1250, a file storage unit 1260, a usage history DB 1270, a display settings storage unit 1280, and a controller 1290.

The file request input unit 1201 is used by the users to designate a file (a document or a folder) to be displayed. The file retriever 1210 retrieves the designated file from the file storage unit 1260, and outputs the file to the display style changing unit 1230.

The usage history storing unit 1220 stores usage history of files stored in the file storage unit 1260, and calculates a utilization rate of each file based on the usage history. Since only one user uses the information display device 1200, the utilization rate is calculated based on the usage history of the user. For example, the utilization rate is calculated as follows: (the number of times for which a file is used)/(the sum thereof for all files). The display style changing unit 1230 changes the display style of the file input from the file retriever 1210 based on the utilization rate calculated by the usage history storing unit 1220. The display settings changing unit 1240 changes the display settings according to the instruction from the user.

The display unit 1250 displays the designated file on a display device. The file storage unit 1260 stores documents (including text, image, etc.) and folders. The usage history DB 1270 stores the usage history of information stored in the file storage unit 1260. The display settings storage unit 1280 stores the display settings input from the user. The controller 1290 controls the entire information display device 1200.

According to the second embodiment, the usage history storing unit 1220 stores the usage history of files stored in the file storage unit 1260, and the display style changing unit 1230 changes the display style of the file based on the usage history. Therefore, the frequently-used documents and folders can be displayed noticeably.

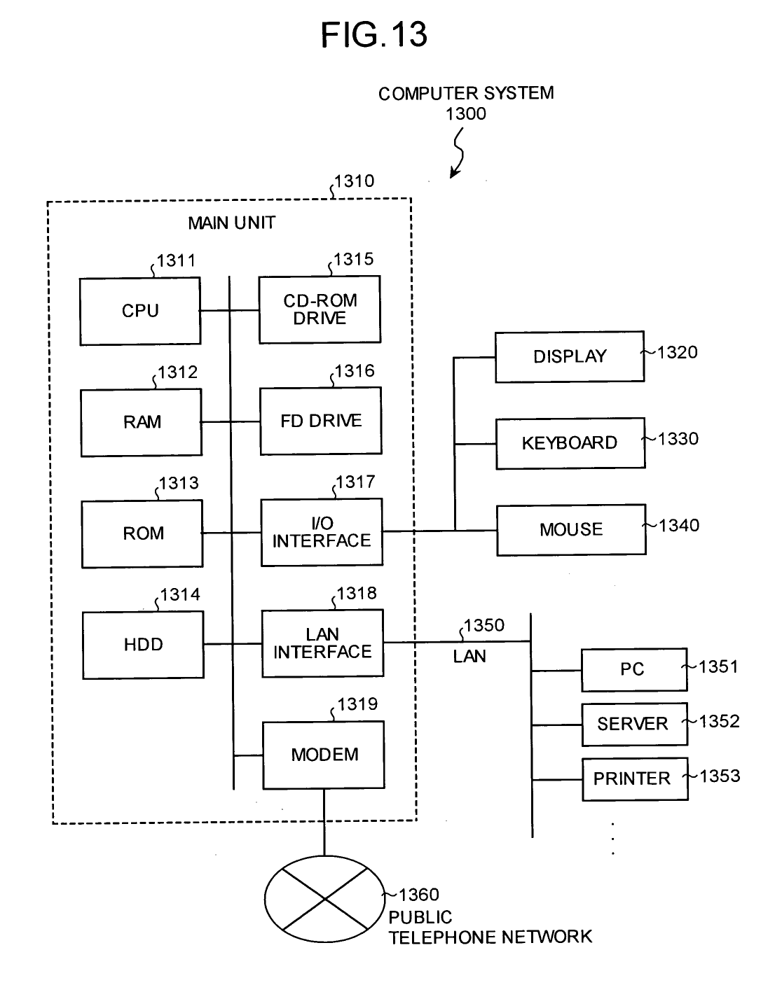

The information providing device, the usage history managing device, and the information display device that are explained in the first and the second embodiments can be realized by computer program. FIG. 13 is a diagram of a computer system executing the computer program according to the present invention. As shown in FIG. 13, a computer system 1300 includes a main unit 1310, a display 1320, a keyboard 1330, and a mouse 1340. The main unit 1310 includes a central processing unit (CPU) 1311, a random access memory (RAM) 1312, a read only memory (ROM) 1313, a hard disk drive (HDD) 1314, a compact disk read only memory/digital versatile disk (CD-ROM/DVD) drive 1315, a floppy disk (FD) drive 1316, an input/output (I/O) interface 1317, a local area network (LAN) interface 1318, and a modem 1319.

The computer system 1300 can be connected to another computer system 1351, a server 1352, a printer 1353, and the like via a LAN 1350 connected to the LAN interface 1318. The computer system 1300 can be also connected to a public telephone network 1360 via the modem 1319.

The computer program executed by the computer system 1300 is stored in portable storage media such as an FD, a CD-ROM, a DVD disk, a magneto optical disk, and an integrated circuit (IC) card. Alternatively, the computer program can be stored in a database of the server 1352 connected via the LAN interface 1318, a database of another computer system 1351, a database of another computer system connected via the public telephone network 1360, and the like. The program is read from the storage media or the databases to be installed into the computer system 1300. The installed computer program is stored in the HDD 1314, and executed by the CPU 1311 using the RAM 1312, the ROM 1313, and the like.

As explained above, according to the present invention, usage history of information (web page, document, folder, and the like) is stored to change the display style of information based on the utilization rate. Accordingly, frequently-used information is displayed noticeably, thereby improving the efficiency of information retrieval.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A method of providing information to a client device via a network, the method comprising:
storing a usage history of the information; and
changing a style of displaying the information based on the usage history.

2. The method according to claim 1, further comprising calculating an index value based on the usage history, wherein
the changing includes changing the style of displaying the information based on the index value.

3. The method according to claim 2, further comprising changing a calculation method for the index value.

4. The method according to claim 2, wherein the calculating includes calculating the index value based on a part of the usage history corresponding to a specific user.

5. The method according to claim 1, wherein
the changing includes changing the style of displaying the information based on a setting, and
the method further comprises changing the setting.

6. The method according to claim 1, wherein the changing includes changing a size of any one of a character and an image representing a link to the information.

7. The method according to claim 1, wherein the changing includes changing a color of any one of a character and an image representing a link to the information.

8. The method according to claim 1, wherein the changing includes changing a color of a background of a link to the information.

9. A computer-readable recording medium that stores a computer program for providing information to a client device via a network, the computer program causes a computer to execute:
storing a usage history of the information; and
changing a style of displaying the information based on the usage history.

10. The computer-readable recording medium according to claim 9, wherein the computer program further causes the computer to execute calculating an index value based on the usage history, wherein
the changing includes changing the style of displaying the information based on the index value.

11. The computer-readable recording medium according to claim 9, wherein the calculating includes calculating the index value based on a part of the usage history corresponding to a specific user.

12. The computer-readable recording medium according to claim 9, wherein
the changing includes changing the style for displaying the information based on a setting, and
the computer program further causes the computer to execute changing the setting.

13. A computer-readable recording medium that stores a computer program for displaying information in response to a request from a user, wherein the computer program causes a computer to execute:
storing a usage history of the information; and
changing a style of displaying the information based on the usage history.

14. The computer-readable recording medium according to claim 13, wherein
the changing includes changing the style of displaying the information based on a setting, and
the computer program further causes the computer to execute changing the setting.

15. An information providing device that provides information to a client device via a network, the information providing device comprising:
a usage history storing unit that stores a usage history of the information; and
a display style changing unit that changes a style of displaying the information based on the usage history.

16. The information providing device according to claim 15, further comprising an index value calculating unit that calculates an index value based on the usage history, wherein
the display style changing unit changes the style of displaying the information based on the index value.

17. The information providing device according to claim 15, wherein the index value calculating unit calculates the index value based on a part of the usage history corresponding to a specific user.

18. The information providing device according to claim 15, wherein
the display style changing unit changes the style for displaying the information based on a setting, and
the information providing device further comprises a setting changing unit that changes the setting.

19. An information display device that displays information in response to a request from a user, the information display device comprising:
a usage history storing unit that stores a usage history of the information; and
a display style changing unit that changes a style of displaying the information based on the usage history.

20. The information display device according to claim 19, wherein
the display style changing unit changes the style of displaying the information based on a setting, and
the information display device further comprises a setting changing unit that changes the setting.
